(19) United States
(12) Patent Application Publication
(10) Pub. No.: US 2008/0271369 A1
(43) Pub. Date: Nov. 6, 2008

(54) GREENS MISTER AND METHOD

(76) Inventor: JOHN KEVIN HUTCHINS, Trabuco Canyon, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/761,507

(22) Filed: Jun. 12, 2007

Related U.S. Application Data
(60) Provisional application No. 60/915,625, filed on May 2, 2007.

(51) Int. Cl. A01G 13/00

(52) U.S. Cl. 47/58.1 R

(57) ABSTRACT

Apparatus for spraying atomized water for cooling golf green turf grass generally includes a chute having a circular intake attachable to a blower and exhaust having a generally rectangular perimeter with a sides contouring from the circular intake to the exhaust perimeter in order to provide a generally rectangular exhaust air flow. Vertically oriented linear arrays of water nozzle disposed on opposing sides of the exhaust perimeter are provided for limiting side way diffusion of the air exhaust from the chute. The nozzles are interconnected with a water supply through a pump.

This application claims priority from U.S. Provisional Patent Application Ser. No. 60/915,625 filed May 2, 2007. This provisional patent application is to be incorporated herewith in its entirety.

The present invention is generally related to golf course care and is more particularly directed to apparatus and methods for spraying atomized water in order to cool golf green turf grass and reduce heat stress and death thereof.

Turf grass, for example, bent grass, is desirable for golf course greens since it provides for excellent roll and smoothness characteristics for golf balls. However, during hot weather the first part of the turf grass to suffer is the root system. The root growth will slow down which results in a concomitant decrease in the growth of new turf foliage.

As temperatures increase, the roots struggle more and eventually stop functioning which, in turn, leads to a complete shut down of turf growth. If temperatures remain too high, such as, for example, over 90° degrees, large patches of turf will turn brown or white as the entire turf plant gradually dies.

It is often assumed that air temperature is a good indicator of turf cantopy temperature. However, turf cantopy temperatures can generally run 10° to 15° F. higher than the air temperature during the peak heat of the summer, particularly if there is no wind. Other factors such as relative humidity, soil moisture, wind speed and compaction can effect the turf cantopy temperature. Thus, on any given golf course some greens will fail during hot weather while others will not.

Heretofore, a method for cooling of turf greens has been to water the greens in order aid in both conductive and evaporative cooling.

Unfortunately, this method may result in the application of excess amounts of water to the turf grass which can lead to growth of algae and disease.

In an effort to overcome the problems associated with over watering of greens, fans and misters have been developed, see for example U.S. Pat. No. 6,223,995 to Evans, et al. These machines are adapted from a snow blowing machines and accordingly do not effectively dispense and control atomized water in order to effect efficient green cooling.

The present invention provides for apparatus and methods which enable effective cooling of golf green turf grass.

### SUMMARY OF THE INVENTION

Apparatus in accordance with the present invention for spraying atomized water in order to cool golf green turf grass and relieve stress and death thereof generally includes a chute having a circular intake attachable to a blower along with an exhaust having generally a rectangular perimeter with sides contouring from the circular intake to the exhaust perimeter in order to provide a generally rectangular exhaust air flow.

Vertically oriented linear arrays of water nozzles are disposed on opposite sides of the exhaust perimeter for both projecting water in a planer direction aligned with a side of the rectangular exhaust air flow and limit the sideway diffusion of the air exhaust from the chute. In this manner, better control of the directional atomized water is made possible compared to prior art blowers. A water supply is provided along with a pump interconnected between the water supply and the nozzle.

Additional apparatus suitable for performing a method in accordance with the present invention generally includes a turf green canopy temperature measuring instrument along with a log for recording measured canopy temperature and measurements.

The method of the present invention generally includes circling a golf green with the apparatus of the present invention while directing a flow of atomized water over the golf green while circling. Following stopping of circling and flow of atomized water, a turf canopy temperature of the golf green is measured and logged in a log report.

Thereafter, these steps are repeated until a selected temperature is reached.

In addition, the method may include controlling a rate of flow of atomized water in order to control a spray pattern of the atomized water.

### BRIEF DESCRIPTION OF THE DRAWINGS

The present invention may be more clearly understood with reference to the following detailed description in conjunction with the appended drawings of which:

FIG. 1 is a perspective view of the apparatus in accordance with the present invention generally showing a chute along with a water supply and a pump interconnected between the water supply and nozzles disposed on opposing sides of the chute, a temperature recording is also diagramed;

FIG. 2 is a perspective view of the apparatus shown in FIG. 1 as is may be coupled to a conventional blower and towed by a conventional utility vehicle;

FIG. 3 is a perspective view of the chute shown in FIG. 1;

FIG. 4 is a perspective view of the chute similar to that shown in FIG. 3 with an illustration of the projected air exhaust provided by the features of the present invention;

FIG. 5 is an illustration of the method in accordance with the present invention in which a golf green is circled and atomized water is directed over the golf green; and

FIG. 6 is an illustration of a suitable log report in accordance with the present invention.

### DETAILED DESCRIPTION

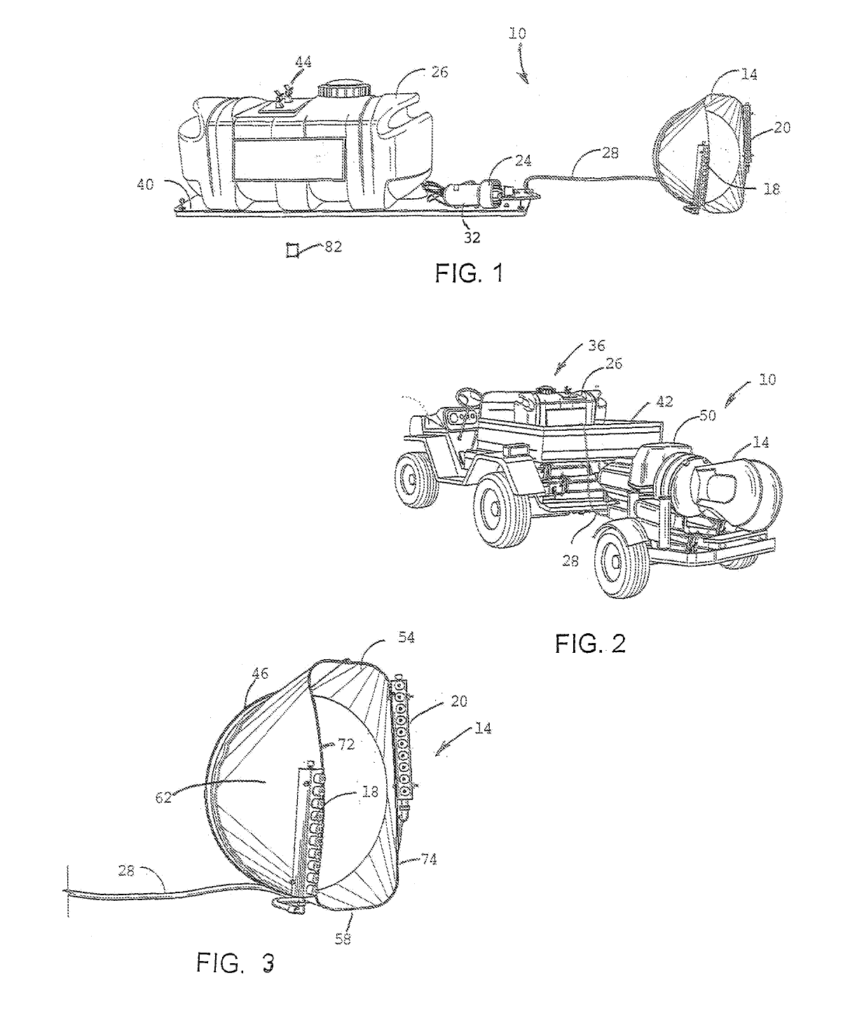

With reference to FIG. 1, there is shown an apparatus 10 in accordance with the present invention for spraying atomized water in order to cool golf green turf grass (not shown in FIG. 1) with the apparatus 10 generally including a chute 14 with linear arrays of the nozzles 18, which may be of conventional design, interconnected to a pump 24 and water supply 26 through a line 28. The water supply, or tank, 26 and pump also may be of conventional design with the water pump 24 preferably being operated by a 12-volt motor which may be interconnected to the battery/power supply of a utility vehicle 36 as shown in FIG. 2.

The tank 26, pump 24 may be disposed on a portable platform 40 for convenient mounting on a truck bed 42 of the vehicle 36 and a bracket 44 may be provided atop the tank 26 for receiving the chute 14 when not in use.

With reference to FIG. 3, the chute 14, which may be formed from fiberglass or the like, preferably includes a circular intake 46 attachable to a conventional blower 50 as shown in FIG. 2. A suitable blower is made by Buffalo Turban Model Cyclone KB3 (Springville, N.Y.).

With further reference to FIG. 3, the chute 14 includes an exhaust 54 having a generally rectangular perimeter 58 with sides 62 contouring from the circular intake 46 to the exhaust perimeter 58. This results in a generally rectangular exhaust airflow 66 as illustrated in FIG. 4. This directed airflow 66 enables greater control for projecting atomized water than in prior art devices which disperse water, or snow, in a generally uncontrolled manner.

Further, directional control of the exhaust airflow 66 is provided by the nozzle arrays 18, 20 which are disposed on opposing sides 72, 74 of the chute 14 which, as also illustrated in FIG. 4, project water in generally planar direction aligned with a side 78 of the airflow 66.

A method in accordance with the present invention utilizes a conventional bead thermocouple probe, or digital thermometer, 82 as diagramed in FIG. 1. Such probes and thermometers are well-known in the art as for example available from Granger B Thermacable Probe No. 1T322 or digital thermometer No. 4PC59, see www.Granger.com.

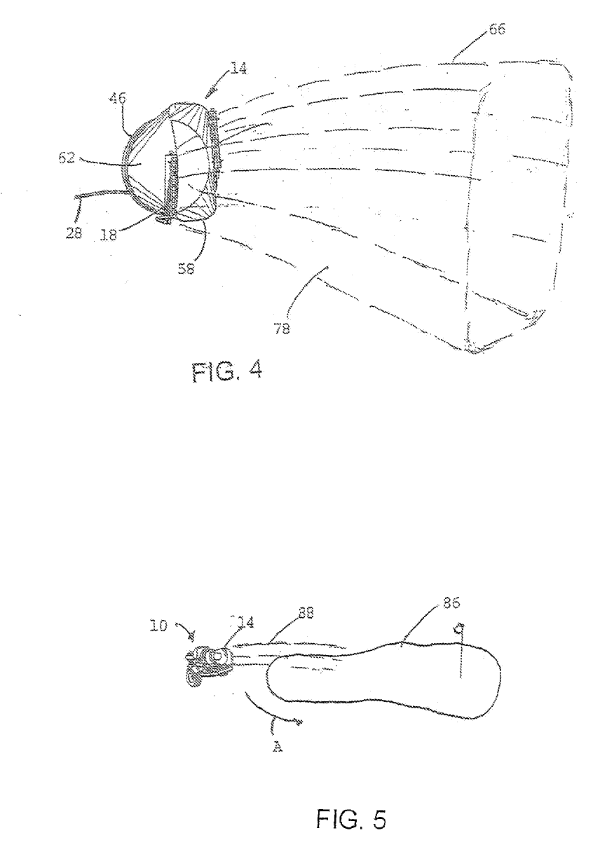

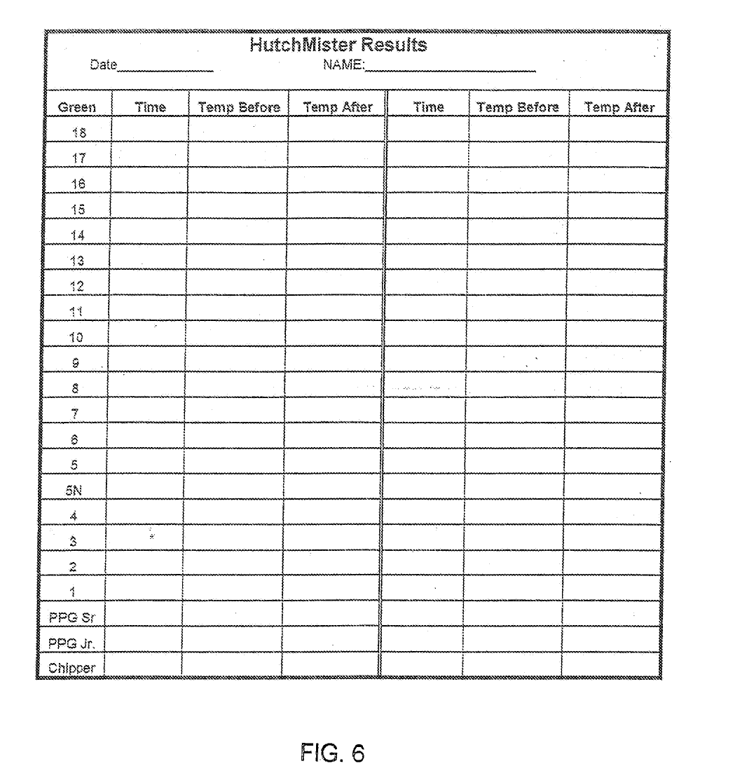

In conjunction therewith, a report log, which is part of the present invention and illustrated in FIG. 6, is useful in a method in accordance with the present invention for spraying atomized water in order to cool golf green turf grass and reduce heat stress and death thereof. As illustrated in FIG. 5, the method of the present invention includes a circling a golf green 86, as indicated by arrow A, with the apparatus 10 and directing a flow of atomized water 88 over the green 86 while circling. Periodically, the circling is stopped and the turf canopy temperature of the golf green 86 is measured utilizing the probe 82 and logging the measured temperature in the log report such as illustrated in FIG. 6. This process is repeated until a selected temperature is reached, for example, 90° F., is reached.

In addition, the pump 24 may be controlled in a conventional manner to vary pressure and volume to provide rates of flow of atomized water to further control the spray pattern of atomized water.

Although there has been hereinabove described a specific greens mister and method in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

1. Apparatus for spraying atomized water in order to cool golf green turf grass and reduce heat stress and death thereof, said apparatus comprising:
a chute having a circular intake attachable to a blower and an exhaust having a generally rectangular perimeter with sides contouring from the circular intake to the exhaust perimeter in order to provide a generally rectangular exhaust air flow;
linear arrays of water nozzles disposed on opposing sides of the exhaust perimeter for projecting water in a planar direction aligned with the a side of the rectangular exhaust air flow;
a water supply; and
a pump interconnect said water supply with the nozzle.

2. The apparatus according to claim 1 wherein the linear arrays of nozzles on the opposing sides are vertically oriented.

3. The apparatus according to claim 2 further comprising a turf green canopy temperature measuring instrument.

4. The apparatus according to claim 3 further comprising a log for recording measured canopy temperature measurements.

5. Apparatus for spraying atomized water in order to cool golf course turf grass and reduce heat stress and death thereof, said apparatus comprising:
a chute having a circular intake attached to a blower and an exhaust having a generally rectangular perimeter with sides contouring from the circular intake to the exhaust perimeter;
vertically oriented linear arrays of water nozzles disposed on opposing sides of the exhaust perimeter for limiting sideway diffusion of air exhaust from said chute.

6. The apparatus according to claim 5 further comprising a turf green canopy temperature measuring instrument.

7. The apparatus according to claim 6 further comprising a log for recording measured canopy temperature measurements.

8. A method for spraying atomized water in order to cool golf green turf grass and reduce heat stress and death thereof, said method comprising:
a) circling a golf green with the apparatus of for spraying atomized water, and
b) directing a flow of atomized water over the golf green while circling.

9. The method according to claim 8 farther comprising controlling a rate of flow of atomized water in order to control a spray pattern of the atomized water.

10. The method according to claim 8 wherein circling a golf green comprised circling the golf green with the apparatus of claim 1.

11. The method according to claim 8 further comprising:
c) stopping the circling and flow of atomized water;
d) measuring turf canopy temperature of the golf green;
e) logging the measured temperature in a log report and repeating a-e until a selected temperature is reached.

12. The method according to claim 9 further comprising:
c) stopping the circling and flow of atomized water;
d) measuring turf canopy temperature of the golf green;
e) logging the measured temperature in a log report and repeating a-e until a selected temperature is reached.

13. The method according to claim 10 further comprising:
c) stopping the circling and flow of atomized water;
d) measuring turf canopy temperature of the golf green;
e) logging the measured temperature in a log report and repeating a-e until a selected temperature is reached.
